(19) United States
(12) Patent Application Publication
(10) Pub. No.: US 2005/0178279 A1
(43) Pub. Date: Aug. 18, 2005

(54) Method and apparatus for printing an image on an irregular surface

(76) Inventor: Josep Valls, Charlotte, NC (US)

Correspondence Address: MAYER, BROWN, ROWE & MAW LLP, P.O. BOX 2828, CHICAGO, IL, 60690-2828, US

(21) Appl. No.: 11/041,015

(22) Filed: Jan. 21, 2005

Related U.S. Application Data
(60) Provisional application No. 60/537,840, filed on Jan. 21, 2004.

(51) Int. Cl. B41F 17/30; B41M 1/40; B41J 2/01

(52) U.S. Cl. 101/38.1; 101/35; 347/2

(57) ABSTRACT

An inkjet printing system is described that permits printing of ink on irregular surfaces such as a substantially circular Christmas ornament.

### This application is a continuation of co-pending Provisional U.S. Patent Application Ser. No. 60/537,840, filed Jan. 21, 2004, hereby incorporated by reference herein.

### FIELD

The present application relates to inkjet printing systems, and more particularly, to an inkjet printing system that prints images on irregular surfaces.

### BACKGROUND

Inkjet printing systems exist for printing images on paper and a variety of substrates, including common household surfaces. However, these inkjet printing systems do not provide the ability to print on highly irregular surfaces such as large (or thick) wood moldings, circular objects or other surfaces that require an adjustable inkjet printing system for a variety of thicknesses, lengths and shapes of objects. Also, many of these surfaces are not only thick, but have curves and detailed etching on the surfaces that make inkjet printing of an image difficult on such a surface. In addition, these systems do not provide for printing images on circular or spherical objects, such as holiday ornaments.

A need therefore exists for an inkjet printing system that may be adjustable to print images on irregular surfaces of any size, shape, irregularity, length or material.

### SUMMARY OF THE INVENTION

An inkjet printing system for printing an image on a irregular surface of a material is described. The inkjet printing system includes a print bed device that is adjustable by height and width to print an image on any material. The print bed device is connected to a computer system to deliver images to the print bed device to print the image on a material. The material includes irregular surfaces for common household items including tiles, moldings, lumber, wood, glass, marble, ornaments and the like, regardless of the shape or composition of the material.

Also described, in an alternative embodiment, is a method for printing an image on a substantially circular ornament, such as a Christmas ornament. This method includes the steps of providing the substantially circular ornament, providing an inkjet printing system where the inkjet printing system has a computer system in communication with an ornament print bed device. The ornament print bed device has at least one clamping device to clamp the substantially circular ornament to the ornament print bed device. The clamping device is able to rotate the substantially circular ornament. The next step includes pre-coating the substantially circular ornament with an adhesive material and allowing the adhesive material to substantially dry. Then the substantially circular ornament is clamped onto the clamping device. The image from the computer system is sent to the ornament print bed device and the image is printed onto the substantially circular ornament using the ornament print bed device by rotating the substantially circular ornament using the clamping device and placing ink from the inkjet printing system onto the substantially circular ornament at locations on the substantially circular ornament determined by the computer system to form the image on the substantially circular ornament.

In alternative embodiments, the method described above may be further used with other substantially circular objects, such as balls (baseballs, golf balls, tennis balls and other balls).

### BRIEF DESCRIPTION OF THE DRAWINGS

A more complex appreciation of the invention and many of the advantages thereof will be readily obtained as the same becomes better understood by references to the detailed description when considered in connection with the accompanying drawings, wherein:

FIG. 1 is a perspective view of an embodiment of the inkjet printing system of the present invention;

FIG. 2 is a perspective view of an embodiment of the drive assembly used in an embodiment of the inkjet printing system of the present invention;

FIG. 3 is a perspective view of the backside of the device of FIG. 2;

FIG. 4 is a perspective view of an embodiment of the wheel assemblies of an embodiment of the inkjet printing system of the present invention;

FIG. 5 is a perspective view of the backside of the wheel assemblies of FIG. 4;

FIG. 6 is a block diagram view of an embodiment of a computer system used in conjunction with the inkjet printing system of the present invention;

FIG. 7 is a front view of an alternative embodiment of an inkjet printing system of the present invention;

FIG. 8 is a side, transparent view of an alternative embodiment of an inkjet printing system of the present invention; and

FIG. 9 is front view of an alternative embodiment of an inkjet printing system of the present invention.

### DETAILED DESCRIPTION OF THE PREFERRED EMBODIMENT

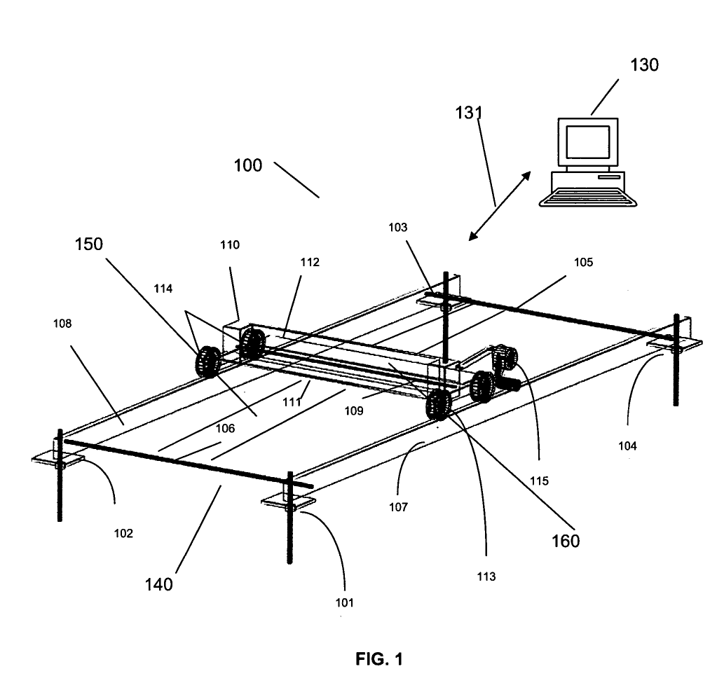

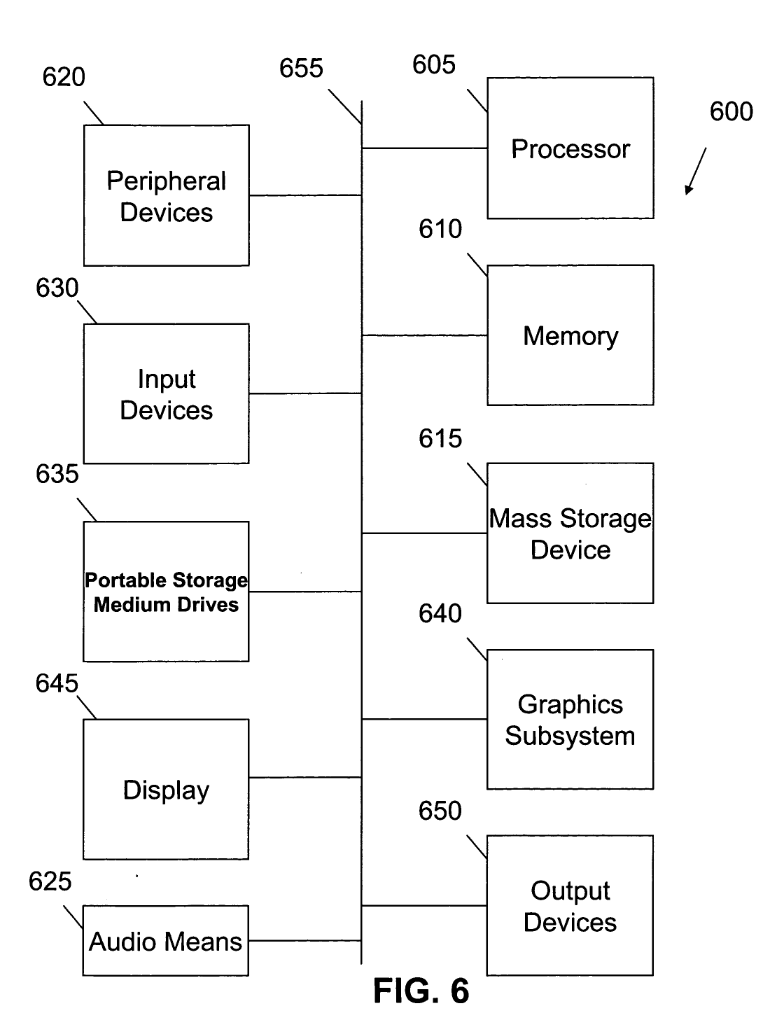

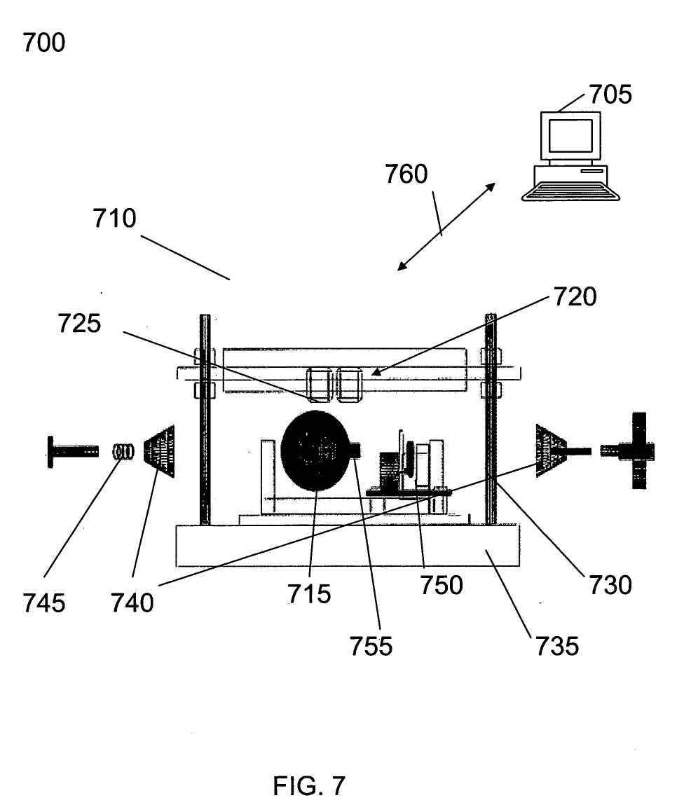

FIG. 1 is a perspective view of an embodiment of the inkjet printing system of the present invention. In FIG. 1, an inkjet printing system 100 is shown that includes a computer system 130 in communication with a print bed device 140. In this embodiment, the computer system 130 may be any standard conventional computer system, such as the computer system shown and described with regard to FIG. 6 below. The computer system 130 contains the software to receive a digital image of a surface of a material 150 that is scanned, using conventional scanners, as a digital image of the irregular surface into memory of the computer system 130. In one embodiment, the computer system 130 uses image processing software such as Adobe® Photoshop® to receive and manipulate the digital image. In one embodiment, common household items such as tiles, molding, lumber, wood, glass, marble or similar items are scanned (using a scanner) into a digital image of such common household items and stored onto the computer system 130. On the computer system 130 is also stored a digital design of the design that a user wishes to place on the material 150 that will be put on the print bed device 140 of FIG. 1. The material is any common household items as described above. It is understood that the material 150 may include items that have a highly irregular shape such as the items described above. Additional items can include circular objects, such as Christmas or other holiday ornaments, that use the print bed embodiments of FIGS. 7-9 below. Thus, when the image of such irregular surfaces are placed into a scanner and stored digitally, as is well known in the art, into the computer system 130, the shadings created by the scanner due to the depth irregularities on the surface will be shown on the digital image through darker or lighter shadings of gray. Using software such as Adobe® Photoshop® to manipulate the shadings, the computer system 130 is capable of directing the print bed device 140 along the irregular surfaces as more fully described below to print a design on the material 150. It is understood that the design may be any digital image representing any design or picture (e.g. photograph). The computer system 130 also contains the digital design that will be inkjet printed onto the material 150, such as a wall molding, in one embodiment. In the computer system 130, the digital design is super-imposed onto a digital surface image of the material 150 and dissected into discrete strips. The computer system 130 is in communication 131 with the print bed device 140 through standard data transmission. This data transmission is done using any data transmission medium, including infra-red, cellular, radio-frequency, satellite, Bluetooth® technology or standard cables. The communication means 131 is between the computer system 130 and the print bed device where the computer system 130 is able to control the inkjet printer that is part of the print head mechanism 160. A numerical pressure gradient is identified for each discrete strip by the computer system 130 to control the print head mechanism 160. Specifically, the pressure gradient is used to control the inkjet nozzle on the print bed device 140 to compensate for distance variations between the inkjet nozzle and the print surface of the material 150. The modified discrete strips are realigned into a digital design that has been modified, hereinafter termed the modified digital design. The modified digital design includes a print surface size, length, width, and nozzle pressure settings. At this point, the modified digital design is stored on the computer system 130 and is ready for printing onto the material 150. The material 150 is, in one embodiment, prepared by placing one or more formulations or coatings onto the material prior to being laid onto the print bed device 140. These formulations or coatings enable the inkjet being placed onto the material 150 by the print bed device 140 to adhere properly to the material 150. It is noted that multiple coatings may be required, in one embodiment, in order for the proper adhesion of the ink. In an alternative embodiment, a solvent-based ink may be used that already has adhesive properties so that a separate pre-coating step of an adhesive material is not necessary. The solvent-based ink may be used in conjunction with a solvent-based ink printer in this embodiment. The modified design is then selected by the computer system 130. The height of the print bed device 140 may be adjusted using the adjustment knobs 101, 102, 103 and 104. These adjustment knobs may be raised in order to print onto a material that is thicker or wider than the current placement of these knobs. A print head mechanism 160 is used to move across the material 150 to place the modified digital design received from the computer system 130 onto the material. Thus, the print head mechanism 160 moves in four directions; laterally from side to side along the material 150 and also back and forth along the print bed device 140. In this manner, the print head mechanism 160 is able to place the modified digital design onto the material 150. It is noted that some tooling may be required to maintain the material 150 in a stable position on the print bed device 140. Such tooling may include any type of clamp or clasp or other mechanism in order to maintain the material 150 as stable as possible on the print bed device 140 while the print head mechanism 160 moves along the print bed device 140. The material is physically aligned in strict agreement to the printing coordinates of the modified digital design, as well as the digital design. Also as part of the print bed device 140 are stabilizing bars 105, 106 that may be adjusted based on the height of the material 150. Also as part of the print bed device 140 are print tracks 107, 108 that work in conjunction with the print head mechanism 160 to coordinate the required speed of the print head mechanism 160 along the print bed device 140. The print head mechanism 160 includes a frame bottom 11, a frame block 109, a frame top 112, a frame reinforcement bar 113, another frame block 110, a frame wheel assembly 114, and a drive assembly 115, all part of the print bed device 140. The print head mechanism 160 also contains print head nozzles (not shown) that place the ink onto the material 150 and are controlled by the computer system 130. In one embodiment, the print head mechanism 160 is a standard ink jet printer that is commercially available and that is integrated into the bed 140 as shown in FIG. 1.

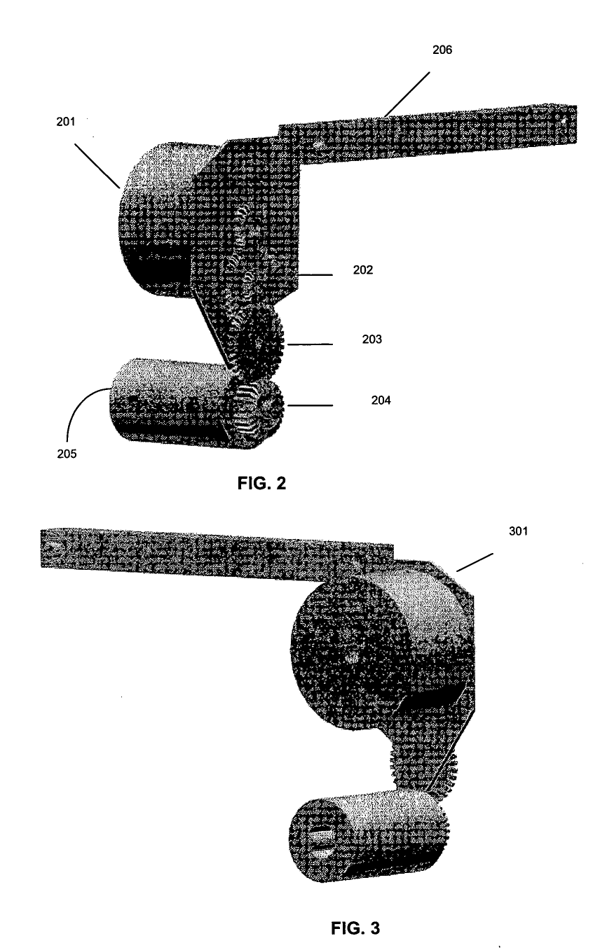

In use, in order to activate the print activation, certain computer instructions are transmitted through communication means 131 to the print bed device 140 from the computer system 130. Specifically, the instructions are sent to the drive assembly 115 (FIG. 2 and FIG. 3). The drive assembly 115 will propel the print head mechanism 160, that contains the printer nozzles that place the ink onto the material 150. It is noted that any standard inkjet printing device may be contained within the print head mechanism 160, such as a Hewlett-Packard® inkjet system, as is known in the art. Still in FIG. 1, the print head mechanism 160 traverses the entire length of the material 150 and places the digital image or modified digital image onto the material 150.

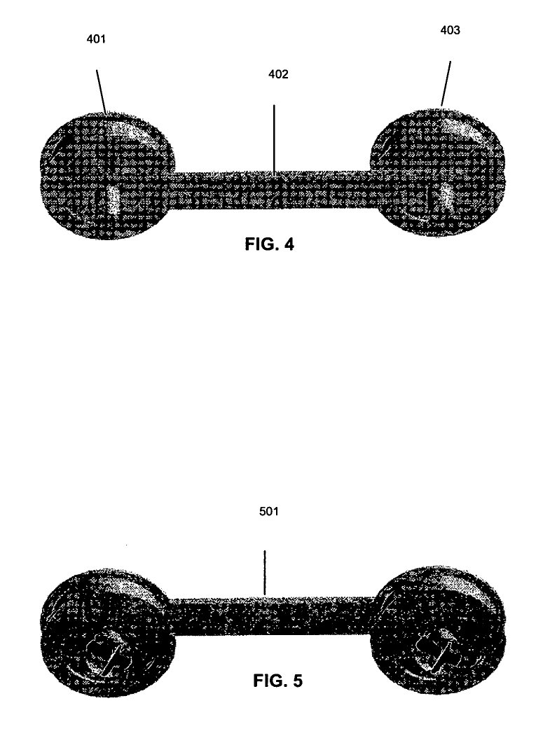

FIG. 2 is a perspective view of an embodiment of the drive assembly used in an embodiment of the inkjet printing system of the present invention. In FIG. 2, the step motor 201 receives electronic instructions from a printer circuit (not shown) that is in communication with the computer system 130. The step motor 201 drives the reduction gears 202, 203 and the roller gear 204 which are attached to the roller 205, all within the print head mechanism 160 of FIG. 1. The drive assembly of FIG. 2 propels the print head mechanism 160 of FIG. 1 along the print bed device 140 to enable the print head mechanism 160 to place the ink onto the material 150. The print head mechanism 160 of FIG. 1 is attached to the wheel assembly (FIG. 4 and FIG. 5) which rotate on the tracks 107, 108 of FIG. 1. The print head mechanism 160 travels at the required speed in coordination with the traversing of the print head (not shown) within the print head mechanism 160. The print head mechanism 160 is fabricated with the parts 109, 110, 111, 112 and 113 described above and shown in FIG. 1. The wheel assemblies (FIG. 4 and FIG. 5) are attached to the print head mechanism 160 (FIG. 1) and are designed to minimize lateral movements of the print head mechanism 160 and to facilitate smooth forward and backward movement along the print bed device 140.

FIG. 3 is a perspective view of the backside of the device of FIG. 2. In FIG. 3, the perspective view 301 shows the step motor 201 and the roller 205 from the backside of those elements.

FIG. 4 is a perspective view of an embodiment of the wheel assemblies of an embodiment of the inkjet printing system of the present invention. In FIG. 4, a rear wheel 401 and a front wheel 403 are shown on the wheel assembly bracket 402 that is shown as element 114 of FIG. 1. Again, as described with regard to FIG. 2 and FIG. 1, the wheel assemblies are attached to the print head mechanism 160 and are designed to minimize lateral movements of the print head mechanism 160 and to facilitate smooth forward and backward movement along the print bed device.

FIG. 5 is a perspective view of the backside of the wheel assembly of FIG. 4. In FIG. 5, the perspective view 501 shows the elements of FIG. 4 from the backside.

FIG. 6 is a block diagram view of an embodiment of a computer system used in conjunction with the inkjet printing system of the present invention. In FIG. 6, the computer system 600 includes a processor 605 for executing program instructions stored in a memory 610. In some embodiments, processor 605 includes a single microprocessor, while in others, processor 605 includes a plurality of microprocessors to define a multi-processor system. The memory 610 stores instructions and data for execution by processor 605, including instructions and data for performing the methods described above. Depending on the extent of software implementation in computer system 600, the memory 610 stores executable code when in operation. The memory 610 includes, for example, banks of read-only memory (ROM), dynamic random access memory (DRAM) as well as high-speed cache memory. Still in FIG. 6, within computer system 600, an operating system comprises program instruction sequences that provide services for accessing, communicating with, and controlling auction server computer system 600. The operating system provides a software platform upon which application programs may execute, in a manner readily understood by those skilled in the art. Further in FIG. 6, the computer system 600 incorporates any combination of additional devices. These include, but are not limited to, a mass storage device 615, one or more peripheral devices 620, an audio means 625, one or more input devices 630, one or more portable storage medium drives 635, a graphics subsystem 640, a display 645, and one or more output devices 650. The various components are connected via an appropriate bus 655 as known by those skilled in the art. In alternative embodiments, the components are connected through other communications media known in the art. In one example, processor 605 and memory 610 are connected via a local microprocessor bus; while mass storage device 615, peripheral devices 620, portable storage medium drives 635, and graphics subsystem 640 are connected via one or more input/output buses.

Continuing in FIG. 6, mass storage device 615 is implemented as fixed and/or removable medium, for example, as a magnetic, optical, or magneto-optical disk drive. The drive is preferably a non-volatile storage device for storing data and instructions for use by processor 605. In some embodiments, mass storage device 615 stores client and server information, code for carrying out methods in accordance with exemplary embodiments of the invention, and computer instructions for processor 605. In other embodiments, computer instructions for performing methods in accordance with exemplary embodiments of the invention also are stored in processor 605. The computer instructions are programmed in a suitable language such as Java, C, Visual or C++. In FIG. 6, the portable storage medium drive 635, in some embodiments, operates in conjunction with a portable non-volatile storage medium, such as a floppy disk, CD-ROM, or other computer-readable medium, to input and output data and code to and from the computer system 600. In some embodiments, methods performed in accordance with exemplary embodiments of the invention are implemented using computer instructions that are stored on such a portable medium and input to the computer system 600 via portable storage medium drive 635. In FIG. 6, the peripheral devices 620 include any type of computer support device, such as an input/output (I/O) interface, to add functionality to computer system 600. The peripheral devices also include input devices to provide a portion of a user interface and may include an alphanumeric keypad or a pointing device such as a mouse, a trackball, a stylus, or cursor direction keys. The I/O interface comprises conventional circuitry for controlling input devices and performing particular signal conversions upon I/O data. The I/O interface may include, for example, a keyboard controller, a serial port controller, and/or digital signal processing circuitry. In FIG. 6, the graphics subsystem 640 and the display 645 provide output alternatives of the system. The graphics subsystem 640 and display 645 include conventional circuitry for operating upon and outputting data to be displayed, where such circuitry preferably includes a graphics processor, a frame buffer, and display driving circuitry. The display 645 may include a cathode ray tube (CRT) display, a liquid crystal display (LCD), or other suitable devices. The display 645 preferably can display at least 256 colors. The graphics subsystem 640 receives textual and graphical information and processes the information for output to the display 645. A video card in the computer system 600 also comprises a part of graphics subsystem 640 and also preferably supports at least 256 colors. For optimal results in viewing digital images, the user should use a video card and monitor that can display the True Color (24 bit color) setting. This setting enables the user to view digital images with photographic image quality.

In FIG. 6, audio means 625 preferably includes a sound card that receives audio signals from a peripheral microphone. In addition, audio means 625 may include a processor for processing sound. The signals can be processed by the processor in audio means 625 of computer system 600 and passed to other devices as, for example, streaming audio signals. In some embodiments, programs for performing methods in accordance with exemplary embodiments of the invention are embodied as computer program products. These generally include a storage medium or medium having instructions stored thereon used to program a computer to perform the methods described above. Examples of suitable storage medium or media include any type of disk including floppy disks, optical disks, DVDs, CD ROMs, magnetic optical disks, RAMs, EPROMs, EEPROMs, magnetic or optical cards, hard disk, flash card, smart card, and other medium. Stored on one or more of the computer readable medium, the program includes software for controlling both the hardware of a general purpose or specialized computer or microprocessor. This software also enables the computer or microprocessor to interact with a human or other mechanism utilizing the results of exemplary embodiments of the invention. Such software includes, but is not limited to, device drivers, operating systems and user applications. Preferably, such computer readable medium further include software for performing the methods described above. In certain other embodiments, a program for performing an exemplary method of the invention or an aspect thereof is situated on a carrier wave such as an electronic signal transferred over a data network. Suitable networks include the Internet, a frame relay network, an ATM network, a wide area network (WAN), or a local area network (LAN). Those skilled in the art will recognize that merely transferring the program over the network, rather than executing the program on a computer system or other device, does not avoid the scope of the invention.

FIG. 7 is a side view of an embodiment of the inkjet printing system of the present invention for use with a substantially circular object. In FIG. 7, the inkjet printing system 700 includes a computer system 705 (for example the computer system of FIG. 6) that is in communication with the ornament print bed device 710. It is understood that the embodiment of FIG. 7 applies to any substantially circular object, for example the substantially circular ornament 715 specifically shown in FIG. 7. Thus, the inkjet printing system 700 may be used for any substantially circular object such as any ball (for example golf ball, tennis ball, soccer ball, baseball, or other type of balls) or any substantially circular object. In essence, the embodiment of FIG. 7 may be used in conjunction with any substantially circular object where an image is to be placed onto that substantially circular object. It is further understood that the term circular as used herein is meant to include shaped objects that are perfectly round, partially round, spherical, oval, cylindrical or other irregularly shaped objects. The apparatus of FIG. 7 is therefore not limited for use to only perfectly round objects, but may also include these other irregularly shaped objects. In the embodiment of FIG. 7, a Christmas ornament is shown as the substantially circular ornament 715 in this embodiment. Still in FIG. 7, there is shown the ornament print bed device 710 containing a number of components. It is understood that this ornament print bed device 710 may also be considered an object print bed device, when used not for an ornament, but for any substantially circular object that is to be placed an image upon. As part of the ornament print bed device 710, there is shown inkjet printer 720 with inkjet printing nozzles 725 that are able to place ink onto the substantially circular ornament 715. The inkjet printer 720 is able to move laterally in an x direction to move over the substantially circular ornament 715. The inkjet printer 720 is supported by supporting members 730 and a supporting base 735. There are shown two clamping devices 740 as part of the embodiment of FIG. 7. It is understood that these clamping devices 740 are used to stabilize the substantially circular ornament 715 underneath the inkjet printer 720 and also to rotate the substantially circular ornament in a circular direction underneath the inkjet printer 720. The clamping devices 740 contain a spring 745 on one of the clamping devices to hold the ornament 715 between the devices 740 and a motor drive assembly 750 near the neck 755 of the substantially circular ornament 715. While the clamping devices 740 are shown to be outside of the supporting member 730 in this view, it is understood that the clamping devices 740 will be in actual contact with the substantially circular ornament when in operation. The motor drive assembly shall be further explained with reference to the figures below.

In operation, the substantially circular ornament 715 is first obtained. In the case of a Christmas ornament, any typical glass Christmas ornament or other material may be used as a starting point for printing an image on that Christmas ornament. In the case of other substantially circular objects, such as a baseball, golf ball, and the like, those objects may be in their standard state after purchase. To print the image on these substantially circular objects, the image is transferred to the computer 705 using well known techniques for transferring data to a computer system, such as the computer system of FIG. 6. The image may be in any one of a number of well known data types, such as TIF or JPEG or other image files. In one embodiment, the image is a photograph of a human being, such as a face of a human being to be placed on the substantially circular ornament 715. That computer 705 is in communication with the inkjet printer using standard communication means as described above. In addition, the computer system 705 uses any one of a variety of image processing software, including, in one embodiment, Adobe® Photoshop®. It is understood that a number of image processing software is available on the market and may be used in alternative embodiments. The computer system 705 is able to transfer the image from the computer to the inkjet printer and control the inkjet printer 720 to place the ink onto the substantially circular ornament as is controlled with any number of image processing software.

The substantially circular ornament 715 is first placed into the ornament print bed device 710 by pulling the clamping device 740 open using the spring 745 in order to provide enough clearance for the substantially circular ornament 715 to be placed between the two clamping devices 740. It is understood that in alternative embodiments, a singular clamping device may be used as long as the substantially circular ornament 715 is able to be stably maintained underneath the inkjet printer 720 and also able to be rotated in a circular motion about its X axis. Once the substantially circular ornament 715 is placed between the clamping devices 740 to be stably maintained underneath the inkjet printer 720 the substantially circular ornament 715 is able to be printed on from the inkjet printer 720 located above the ornament 715. It is understood that, in alternative embodiments, the printer may also be oriented in a lateral position (rather than on top of the ornament 715) to be along the side of the ornament and thereby print on the ornament. The ornament would be similarly rotated to allow printing on the side of the ornament. It is also noted that, prior to placing the substantially circular ornament 715 between the clamping devices 740, the substantially circular ornament 715 is pre-coated with an adhesive material in order to allow the ink placed on the substantially circular ornament 715 to adhere to the substantially circular ornament 715. The adhesive material may be any type of glue or other adhesive well known in the art. In one embodiment, the adhesive material may be adhesives manufactured by William Zinsser and Company Inc. (Product No. 02651) of Somerset, N.J. In alternative embodiments, there may be no need for a pre-coating using an adhesive material when an ink containing adhesive properties is used, for example, a solvent-based ink as described above. After pre-coating the substantially circular ornament 715 with the adhesive material and after allowing sufficient time for the adhesive material to substantially dry, for example, a few hours of time in one embodiment, the substantially circular ornament is placed between the clamping devices 740. The computer system 705 then begins to control the inkjet printer 720 and the motor drive assembly 750 in order to print the image onto the substantially circular ornament 715. The computer system 705 controls the inkjet printer 720 by controlling the inkjet nozzles 725 as is well known with other computer inkjet printers. The computer system 705 also communicates with the motor drive assembly 750 in order to spin the substantially circular ornament along its X axis and thereby place ink from the inkjet printing system onto the substantially circular ornament 715 at the locations determined by the computer software (for example Adobe® Photoshop®) in order to replicate the image from the computer system 705 onto the substantially circular ornament 715. In another embodiment, after the image is placed onto the substantially circular ornament 715 and allowed to dry (for example for a number of hours), the substantially circular ornament is then coated with a protective material, for example the lacquers and polyurethane finishes manufactured by Deft, Inc. of Irvine, Calif. It is further noted that additional embodiments can have more than one coating of either the protective material and/or the adhesive material in order to better protect and/or adhere to the substantially circular ornament, respectively. In a still further embodiment, since the substantially circular ornament 715 may be of clear glass, or, alternatively, may be a color not desired by the intended recipient, a pre-coat of color ink on the substantially circular ornament 715 may be performed. This pre-coat of color ink may, in this embodiment, follow the steps of placing the substantially circular ornament 715 between the clamping device 740 and placing a certain color ink on the substantially circular ornament after an adhesive material has been placed on the substantially circular ornament 715. In an alternative embodiment, the ink itself may have adhesive or protective material already contained within the ink and therefore the adhesive material and protective material steps are not needed. In a still further embodiment, the adhesive material or the protective material may have color ink already as part of the material, so additional ink may not be needed. Again, the color ink is placed over the adhesive material after the adhesive material has been allowed a sufficient time to substantially dry. Then before the image is placed onto the color ink, a second adhesive coating is placed over the color ink and allowed to dry before the image is placed on the substantially circular ornament 715 in this embodiment.

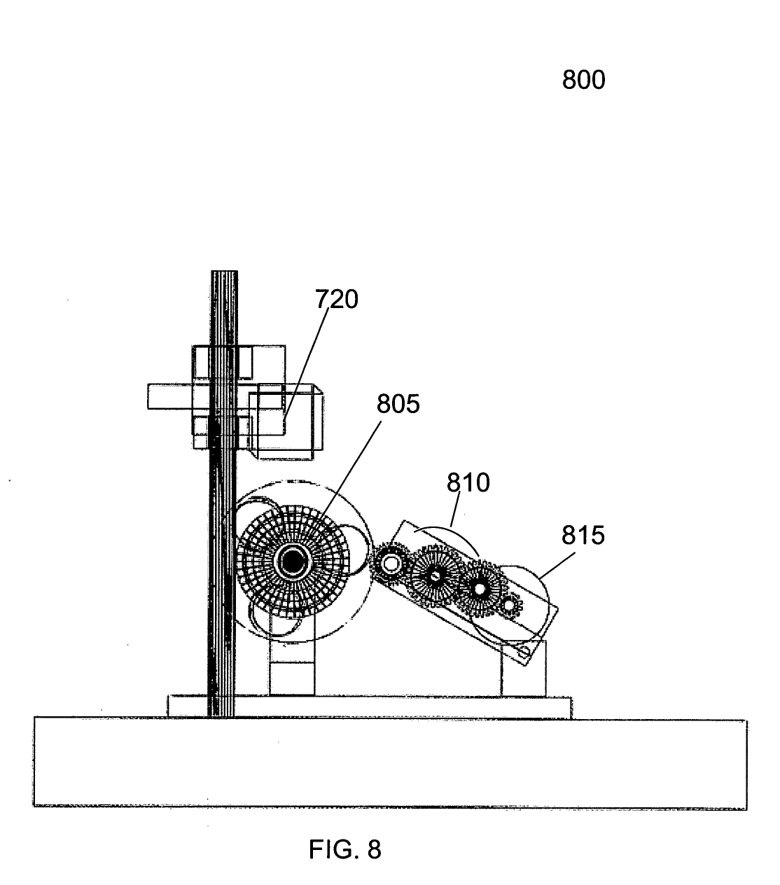

FIG. 8 is a side, transparent view of an embodiment of the inkjet printing system of the present invention. In FIG. 8, the motor drive assembly 750 (now represented by element 800) is shown. In FIG. 8, the clamping device 805 is shown in contact with a number of gears 810 that are being driven by a motor 815. The motor 815 is controlled by the computer system of FIG. 7. From FIG. 8, it is shown that when the motor assembly 815 is turned, the gears translate that movement into a rotating movement for the clamping device 805. It is noted that this clamping device is enabled to rotate, in this embodiment, while the second clamping device (not shown) merely maintains the spring force to hold the substantially circular ornament in place. The inkjet printing device 820 is further shown in this embodiment that would be above the substantially circular ornament (not shown).

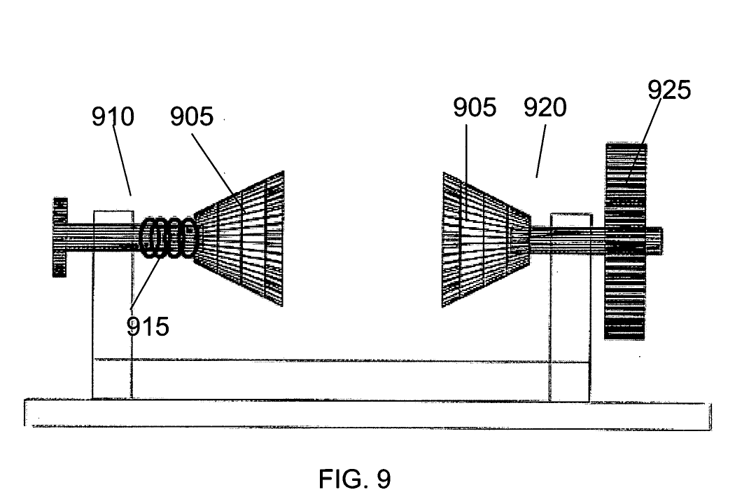

FIG. 9 is a side view of an embodiment of the inkjet printing system of the present invention. In FIG. 9, the clamping devices 905 are shown without the substantially circular ornament placed in between. In this embodiment, a first side 910 has the clamping device 905 connected to a spring 915 that enables force towards the other clamping device in order to maintain the substantially circular ornament (not shown) in contact with the second clamping device 905 on a second side 920. Also shown in FIG. 9 is a portion of the motor drive assembly 925 where this portion is essentially a pulley.

In use, the clamping device 905 on the second side 920 rotates and thereby rotates the substantially circular ornament (not shown) so that the printing device (not shown) may be able to place the ink on a portion of the side of the substantially circular ornament.

It will be understood that the above-described apparatus and method are merely illustrative of applications of the principles of this invention and many other embodiments and modifications may be made without departing from the spirit and scope of the invention as defined in the claims.

1. A method for printing an image on a substantially circular ornament, comprising:
providing the substantially circular ornament;
providing an inkjet printing system, the inkjet printing system having a computer system in communication with an ornament print bed device, the ornament print bed device having at least one clamping device to clamp the substantially circular ornament to the ornament print bed, the clamping device enabling the substantially circular ornament to rotate;
pre-coating the substantially circular ornament with an adhesive material;
allowing the adhesive material to substantially dry;
clamping the substantially circular ornament onto the clamping device;
providing the image from the computer system to the ornament print bed device; and
printing the image onto the substantially circular ornament using the ornament print bed device by
rotating the substantially circular ornament using the clamping device; and
placing ink from the inkjet printing system onto the substantially circular ornament at locations on the substantially circular ornament determined by the computer system to form the image on the substantially circular ornament.

2. The method of claim 1, further comprising:
substantially drying the ink placed on the substantially circular ornament; and
coating the substantially circular ornament with a protective material.

3. The method of claim 1, wherein the image is a digital image of a face of a human being.

4. The method of claim 1, wherein the substantially circular ornament is a substantially circular Christmas ornament.

5. The method of claim 1, further comprising:
allowing the adhesive coating to substantially dry; and
placing a second adhesive coating on the substantially circular ornament.

6. The method of claim 1, further comprising:
placing a color ink on the substantially circular ornament after placing the adhesive coating;
allowing the color ink to substantially dry;
placing a second adhesive coating on the color ink prior to printing the image on the substantially circular ornament.

7. The method of claim 1, wherein the substantially circular ornament is a round Christmas ornament.

8. The method of claim 1, wherein the substantially circular ornament is a spherical Christmas ornament.

9. A method for printing an image on a substantially circular object, comprising:
providing the substantially circular object;
providing an inkjet printing system, the inkjet printing system having a computer system in communication with an object print bed device, the object print bed device having at least one clamping device to clamp the substantially circular object to the ornament print bed, the clamping device enabling the substantially circular object to rotate;
pre-coating the substantially circular object with an adhesive material;
allowing the adhesive material to substantially dry;
clamping the substantially circular object onto the clamping device;
providing the image from the computer system to the object print bed device; and
printing the image onto the substantially circular object using the object print bed device by
rotating the substantially circular object using the clamping device; and
placing ink from the inkjet printing system onto the substantially circular object at locations on the substantially circular object determined by the computer system to form the image on the substantially circular object.

10. The method of claim 9, wherein the substantially circular object is a ball.

11. The method of claim 9, wherein the substantially circular object is a baseball.

12. The method of claim 9, wherein the substantially circular object is a golf ball.

13. The method of claim 9, further comprising:
substantially drying the ink placed on the substantially circular object; and
coating the substantially circular object with a protective material.

14. The method of claim 9, wherein the image is a digital image of a face of a human being.

15. The method of claim 9, further comprising:
allowing the adhesive coating to substantially dry; and
placing a second adhesive coating on the substantially circular object.

16. The method of claim 9, further comprising:
placing a color ink on the substantially circular object after placing the adhesive-coating;
allowing the color ink to substantially dry;
placing a second adhesive coating on the color ink prior to printing the image on the substantially circular object.

17. A method for printing an image on a substantially circular Christmas ornament, comprising:
providing the substantially Christmas circular ornament;
providing an inkjet printing system, the inkjet printing system having a computer system in communication with an ornament print bed device, the ornament print bed device having at least one clamping device to clamp the substantially circular Christmas ornament to the ornament print bed, the clamping device enabling the substantially circular Christmas ornament to rotate;
pre-coating the substantially circular Christmas ornament with an adhesive material;
allowing the adhesive material to substantially dry;
clamping the substantially circular Christmas ornament onto the clamping device;
providing the image from the computer system to the ornament print bed device; and
printing the image onto the substantially circular Christmas ornament using the ornament print bed device by
rotating the substantially circular Christmas ornament using the clamping device; and
placing ink from the inkjet printing system onto the substantially circular Christmas ornament at locations on the substantially circular Christmas ornament determined by the computer system to form the image on the substantially circular Christmas ornament.

18. The method of claim 17, wherein the image is a digital image of a face of a human being.

19. The method of claim 17, wherein the substantially circular Christmas ornament is a spherical Christmas ornament.
